(19) United States
(12) Patent Application Publication
(10) Pub. No.: US 2013/0167141 A1
(43) Pub. Date: Jun. 27, 2013

(54) APPLICATION CONFIGURATION SYSTEM, METHOD, AND PROGRAM

(71) Applicant: Kenji Soejima, Tokyo (JP)

(72) Inventor: Kenji Soejima, Tokyo (JP)

(73) Assignee: NEC CORPORATION, Tokyo (JP)

(21) Appl. No.: 13/820,951

(22) PCT Filed: Aug. 31, 2011
(86) PCT No.: PCT/JP2011/070320

§ 371 Date: Mar. 5, 2013

(30) Foreign Application Priority Data
Sep. 6, 2010 (JP) 2010-198956

(51) Int. Cl. G06F 9/445

(52) U.S. Cl. CPC G06F 8/60
USPC 717/177

(57) ABSTRACT

An application configuration system comprises a second application execution means which includes, an execution means which, after a copy reception control means which makes a storage means store a shared tenant data and unique tenant information copied from a first application execution means to said second application execution means obtains a copy of said shared tenant data from said first application execution means, executes processing according to request information which is inputted from a terminal and is transferred from a request control means to said second application execution means; and a data obtaining means which, when said execution means refers said unique tenant information, in case copying of said unique tenant information to said second application execution means is completed, obtains copied said unique tenant information, and in case said copying is not completed, obtains said unique tenant information of said first application execution means and outputs to said execution means.

### TECHNICAL FIELD

The present invention relates to an application configuration system, a method and a program.

### BACKGROUND ART

In recent years, many applications which utilize a web technology appear. Up to now, each client terminal installed and utilized specific application respectively. However, this application is an application of a style used via a web browser as web service.

On the other hand, there are many cases where such applications of web service mode are utilized by a great deal of client terminals simultaneously. Therefore, for such web applications, it will be a problem how to increase or decrease the scale of the applications while synchronizing with increase or decrease of the number of connected client terminals or the number of requests.

It is difficult to predict the number of such connected client terminals and the number of the requests beforehand. Therefore, when these numbers increase suddenly, the system handles it by extending the scale of the applications. Since this operation generally needs complicated operation and is directly connected with a decline of the service level, it needs to be executed quickly. Accordingly, approaches which automate this operation have been contrived.

For example, in patent document 1, in order to deploy applications automatically according to the situation and make their scale extend, a method to divide server computers into groups and to manage objects to be deployed is proposed.

### PRECEDING TECHNICAL LITERATURE

### Patent Document

[Patent document 1] WO2006/043320

### DISCLOSURE OF INVENTION

### Problem to be Solved

However, the method described in patent document 1 needs to start services after deploying the managed objects to be deployed of which the applications are configured all in the deployment destination server computers in advance. Therefore, in the method described in patent document 1, there is a restriction that relevant server computers cannot process client requests until the deployment of all of the objects to be deployed completes. In case of an application which holds quite much data such as a multi-tenant application, deployment of application takes a long time to complete. Therefore, the method described in patent document 1 has a problem in the aspect of immediate effectivity of load balancing.

The present invention aims, in order to solve such problem, to provide an application configuration system, a method and a program which enable processing of the client requests before deployment of all of the objects to be deployed has been completed.

### Means for Solving the Problem

An application configuration system according to one exemplary embodiment of the present invention includes: a second application execution means which includes, an execution means which, after a copy reception control means which makes a storage means store a shared tenant data and unique tenant information copied from a first application execution means to said second application execution means obtains a copy of said shared tenant data from said first application execution means, executes processing according to request information which is inputted from a terminal and is transferred from a request control means to said second application execution means; and a data obtaining means which, when said execution means refers said unique tenant information, in case copying of said unique tenant information to said second application execution means is completed, obtains copied said unique tenant information, and in case said copying is not completed, obtains said unique tenant information of said first application execution means and outputs to said execution means.

An application configuration method according to one exemplary embodiment of the present invention includes the steps of: among an execution program, a shared tenant data and unique tenant information copied from a first application execution means to said second application execution means, after obtaining a copy of said execution program and a copy of said shared tenant data from said first application execution means, transferring request information inputted from a terminal to said second application execution means; executing said execution program according to said request information; when referring said unique tenant information, obtaining copied said unique tenant information in case copying of said unique tenant information to said second application execution means is completed, and obtaining said unique tenant information of said first application execution means in case said copying is not completed and outputting to said execution program.

An application configuration program which makes a second computer to execute according to the present invention includes the program of: a copy reception control step which makes a storage means store an execution program, a shared tenant data and unique tenant information copied from a first computer to said second computer; an execution step which, in said copy reception control step, after a copy of said execution program and a copy of said shared tenant data were obtained from said first computer in said copy reception control step, executes said execution program according to request information which is inputted from a terminal and is transferred to said second computer, and a data obtaining step which, in said execution step, when referring said unique tenant information, obtains copied said unique tenant information in case copying of said unique tenant information to said second computer is completed, and obtains said unique tenant information of said first computer in case said copying is not completed and makes said execution step refer.

### Effect of the Invention

The present invention provides an application configuration system, a method and a program which enable processing of client requests before deployment of all objects to be deployed has been completed.

### BRIEF DESCRIPTION OF THE DRAWINGS

FIG. 1 is a block diagram showing a configuration of the first exemplary embodiment of the present invention.

FIG. 2 is a flowchart showing operation which copies and transfers shared part of an application according to the operation of the first exemplary embodiment of the present invention.

FIG. 3 is a flowchart showing operation which starts assigning client requests to a copy destination application execution unit 2 according to the operation of the first exemplary embodiment of the present invention.

FIG. 4 is a flowchart showing operation which copies and transfers unique tenant information of an application according to the operation of the first exemplary embodiment of the present invention.

FIG. 5 is a flowchart showing operation when a copy destination application execution unit 2 receives client requests and performs different processing for each tenant according to the operation of the first exemplary embodiment of the present invention.

FIG. 6 is a flowchart showing operation when a copy destination application execution unit 2 receives client requests and performs different processing for each tenant according to the operation of the first exemplary embodiment of the present invention.

FIG. 7 is a flowchart showing operation in case an execution unit 200 obtains a unique tenant data in its processing according to the operation of the first exemplary embodiment of the present invention.

FIG. 8 is a flowchart showing operation in case an execution unit 200 obtains a unique tenant data in its processing according to the operation of the first exemplary embodiment of the present invention.

FIG. 9 is a block diagram showing a configuration of the second exemplary embodiment of the present invention.

FIG. 10 is a flowchart showing operation when a request control unit 20 receives client requests according to the operation of the second exemplary embodiment of the present invention.

FIG. 11 is a flowchart showing operation when a copy destination application execution unit 2 receives client requests and performs different processing for each tenant according to the operation of the second exemplary embodiment of the present invention.

FIG. 12 is a block diagram showing a configuration of the third exemplary embodiment of the present invention.

FIG. 13 is a flowchart showing operation when a copy destination application execution unit 2 receives client requests and performs different processing for each tenant according to the operation of the third exemplary embodiment of the present invention.

FIG. 14 is a flowchart showing operation in case an execution unit 200 obtains a unique tenant data in its processing according to the operation of the third exemplary embodiment of the present invention

FIG. 15 is a flowchart showing operation which copies and transfers unique tenant information of an application according to the operation of the third exemplary embodiment of the present invention.

FIG. 16 is a flowchart showing operation which copies and transfers unique tenant information of an application according to the operation of the third exemplary embodiment of the present invention.

FIG. 17 is a block diagram showing a configuration of the fourth exemplary embodiment of the present invention.

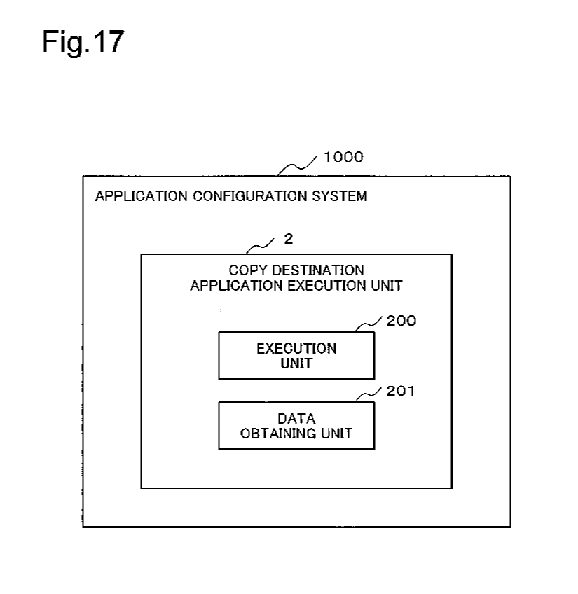

### MODES FOR CARRYING OUT THE INVENTION

Hereinafter, exemplary embodiments of the present invention will be described using drawings. In all drawings, similar code is assigned to similar components, and their description will be omitted appropriately.

Further, each unit which configures such as an application configuration system 1000 of each exemplary embodiment includes: a control unit, a memory, programs loaded in the memory, a storage unit which stores the programs such as a hard disk, an interface for network connection and so on. Also, each unit is realized by an arbitrary combination of hardware and software. And, if not described otherwise, its method of realization and devices are not limited.

Also, the control unit includes CPU (Central Processing Unit) and so on. The control unit makes an operating system operate and controls the whole such as the application configuration system 1000. At the same time, the control unit reads the programs and data from, for example, a recording medium loaded on a drive device and so on to the memory, and executes various processing according to them.

Recording units are, for example, an optical disc, a flexible disc, a magnetic optical disc, an external hard disk, a semiconductor memory and so on. Storage units record computer programs so that computers can read them. Also, the computer programs may be downloaded from an external computer which is not illustrated and is connected to a communication network. Here, if not described otherwise, the communication network may also be such as the internet, a LAN (Local Area Network), a public line network, a wireless communication network or a network configured by such as their combination.

Also, block diagrams used in the description of each exemplary embodiment indicate not a structure in hardware units but the structure in function units. These function blocks are realized by arbitrary combination of hardware and software. Also, in these figures, there are cases where a configured part of each exemplary embodiment is described to be realized by one device which is physically united. However, its realization means of the configured part is not limited to this. That is, the application configuration system 1000 may be realized by a plurality of devices which connected two or more physically separated devices by wire or by wireless. Also, there are cases where each configured part is described such as two or more devices physically separated. However, its realization means of the configured part is not limited to this. That is, the application configuration system 1000 may be realized by one device which is physically united by combining hardware and software arbitrary.

### First Exemplary Embodiment

In the first exemplary embodiment of the present invention, an application configuration system 1000 will be described. When necessity to copy an application and to increase processing capacity arises, the application configuration system 1000 copies each element of which the application is configured step by step.

First, a configuration of the first exemplary embodiment will be described.

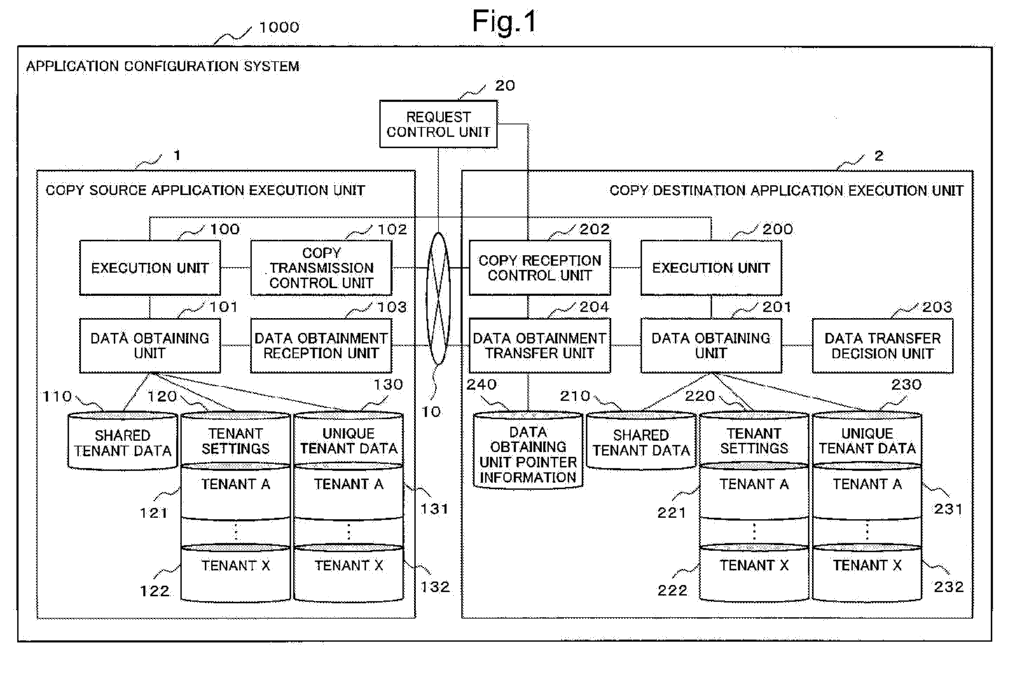

FIG. 1 is a block diagram showing the configuration of this exemplary embodiment. As shown in FIG. 1, the application configuration system 1000 according to the first exemplary embodiment of the present invention includes: a request control unit 20; a copy source application execution unit 1; a copy destination application execution unit 2 and a network 10 which connects them.

The request control unit 20 includes: a function to receive client requests, a function to distinguish a target tenant of client requests and a function to assign requests to the copy destination application execution unit 2.

The copy source application execution unit 1 includes: an execution unit 100; a data obtaining unit 101; a copy transmission control unit 102; a data obtainment reception unit 103; a shared tenant data 110; tenant settings 120 and a unique tenant data 130. Further, there is a case where the copy source application execution unit 1 indicates an application program (copy source application 1) which is executed by a computer and realizes each function of the execution unit 100, the data obtaining unit 101, the copy transmission control unit 102 and the data obtainment reception unit 103.

The execution unit 100 includes a function to execute a program in which business processing of the copy source application execution unit 1 is implemented. The execution unit 100 is, for example, a processor of the copy source application execution unit 1 as a computer. Further, there is a case where the execution unit 100 indicates a program (execution program 100) executed by the processor.

The data obtaining unit 101 includes a function to obtain each data required for the execution unit 100 to execute the business processing.

The shared tenant data 110 is a storage device which holds a business data which is independent of tenants, in other words, is utilized in common way. Also, in the following, there is a case where the shared tenant data 110 expresses the business data itself which is independent of the tenants, in other words, is utilized in common way.

The tenant settings 120 are a storage device which holds each setting information which is needed in order to execute different processing depending on the tenants, such as customization management information for each tenant of an application. Also, in the following, there is a case where the tenant settings 120 express the setting information itself. The tenant settings 120 hold, for example for each tenant, setting information such as tenant settings for tenant A 121 and tenant settings for tenant X 122.

The unique tenant data 130 is a storage device which holds the business data browsed and generated during a process of the business processing for each tenant. Also, in the following, there is a case where the unique tenant data 130 expresses the data itself. The unique tenant data 130 holds, for example for each tenant, the business data such as a unique tenant data for tenant A 131 and a unique tenant data for tenant X 132.

The copy transmission control unit 102 includes: a function to transfer the execution unit 100, the data obtaining unit 101, the shared tenant data 110, the tenant settings 120 and the unique tenant data 130 to equipment on which the copy destination application 2 operates via the network 10.

The data obtainment reception unit 103 includes: a function to receive data obtaining requests from the copy destination application execution unit 2, a function to obtain the tenant settings 120 and the unique tenant data 130 using the data obtaining unit 101 and a function to transmit the obtained data to the copy destination application execution unit 2.

The copy destination application execution unit 2 includes: an execution unit 200, a data obtaining unit 201, a shared tenant data 210, tenant settings 220, a unique tenant data 230, a copy reception control unit 202, a data transfer decision unit 203 and a data obtainment transfer unit 204. Further, there is a case where the copy destination application execution unit 2 indicates an application program (copy destination application 2) which is executed by the computer, and which realizes each function of the execution unit 200, the data obtaining unit 201, the copy reception control unit 202, the data obtainment decision unit 203 and the data obtainment transfer unit 204. The execution unit 200 is copied by the copy source application execution unit 1. Also, the execution unit 200 includes a function to execute the program in which the business processing is implemented. The execution unit 200 is, for example, a processor of the copy destination application execution unit 2 as a computer. Further, there is a case where the execution unit 200 indicates a program (execution program 200) executed by the processor.

The data obtaining unit 201 includes a function to obtain each data which is necessary for the execution unit 200 to execute the business processing, and copied by the copy source application execution unit 1.

The shared tenant data 210 is copied by the copy source application execution unit 1. Also the shared tenant data 210 is the business data which is independent of the tenants and utilized in common way.

The tenant settings 220 are copied by the copy source application execution unit 1. The tenant settings 220 are a storage device which stores each setting information which is needed to execute different processing depending on the tenants, such as customization management information for each tenant of the application. Also, in the following, there is a case where the tenant settings 220 express each of the setting information itself. The tenant settings 220 hold, for example for each tenant, setting information such as tenant settings for tenant A 221 and tenant settings for tenant X 222.

The unique tenant data 230 is copied by the copy source application execution unit 1. The unique tenant data 230 is a storage device which stores the business data browsed and generated during a process of the business processing for each tenant. Also, in the following, there is a case where the unique tenant data 230 expresses the data itself. The unique tenant data 230 holds, for example for each tenant, the business data such as a unique tenant data for tenant A 231 and a unique tenant data for tenant X 232. The tenant settings 120 and 220 and the unique tenant data 130 and 230 are called unique tenant information collectively.

The copy reception control unit 202 includes a function to receive the execution unit 100, the data obtaining unit 101, the shared tenant data 110, the tenant settings 120 and the unique tenant data 130 from the copy source application execution unit 1, to store the data received in equipment and to execute it.

The data transfer decision unit 203 includes a function, for example, to decide whether an access request from the execution unit 200 towards the data obtaining unit 201 for the tenant settings for tenant A 221 and the tenant settings for tenant X 222 is one for the data of which copying has been completed. Also the data transfer decision unit 203 includes a function to decide whether an access request from the execution unit 200 for the unique tenant data for tenant A 231 and the unique tenant data for tenant X 232 is one for the data of which copying has been completed.

The data obtainment transfer unit 204 includes a function to transfer the access request to data which is not copied yet to the data obtainment reception unit 103, and to obtain the tenant settings 120 and the unique tenant data 130.

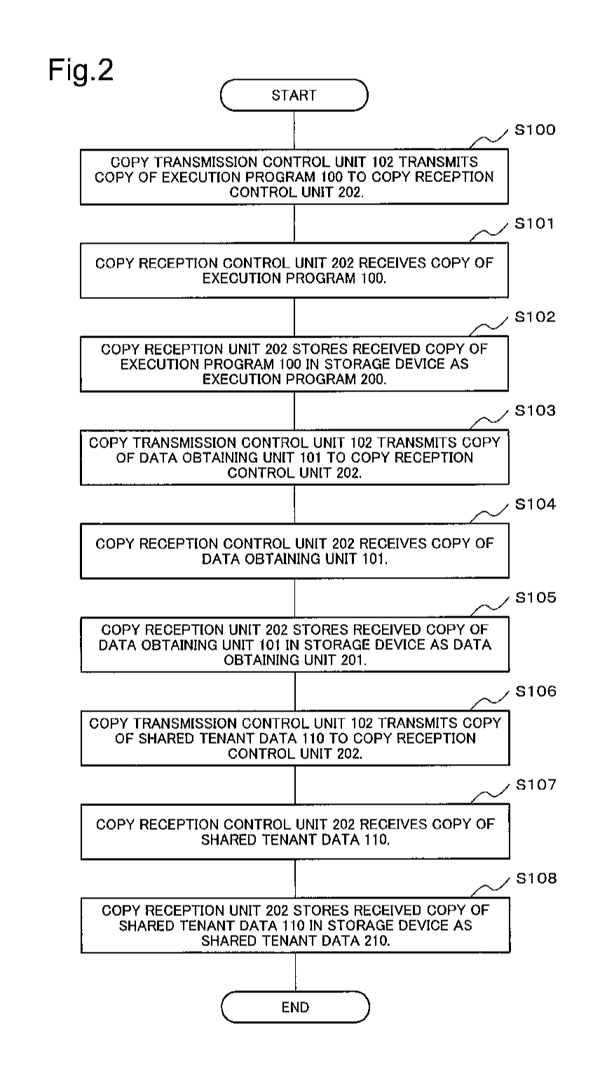

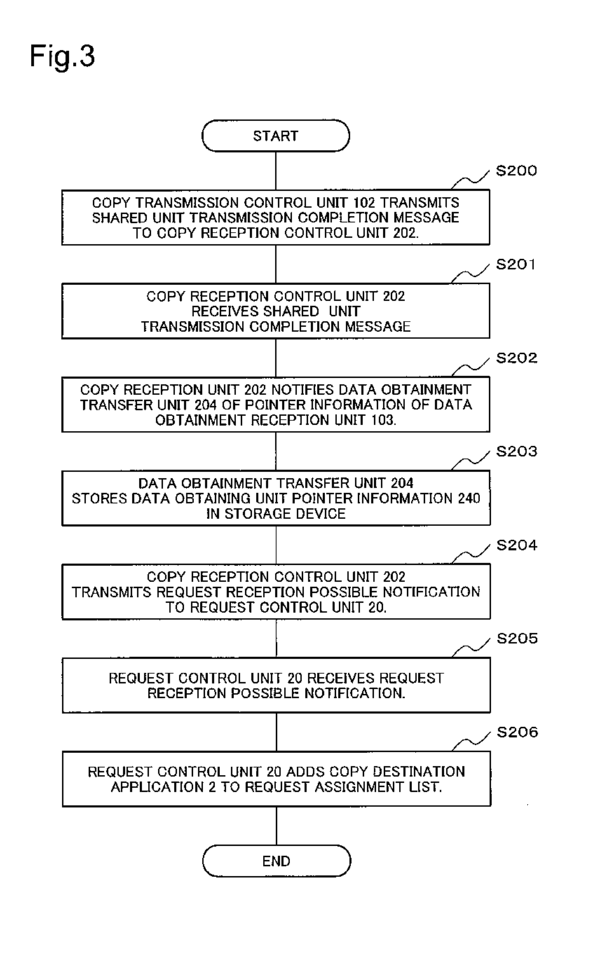

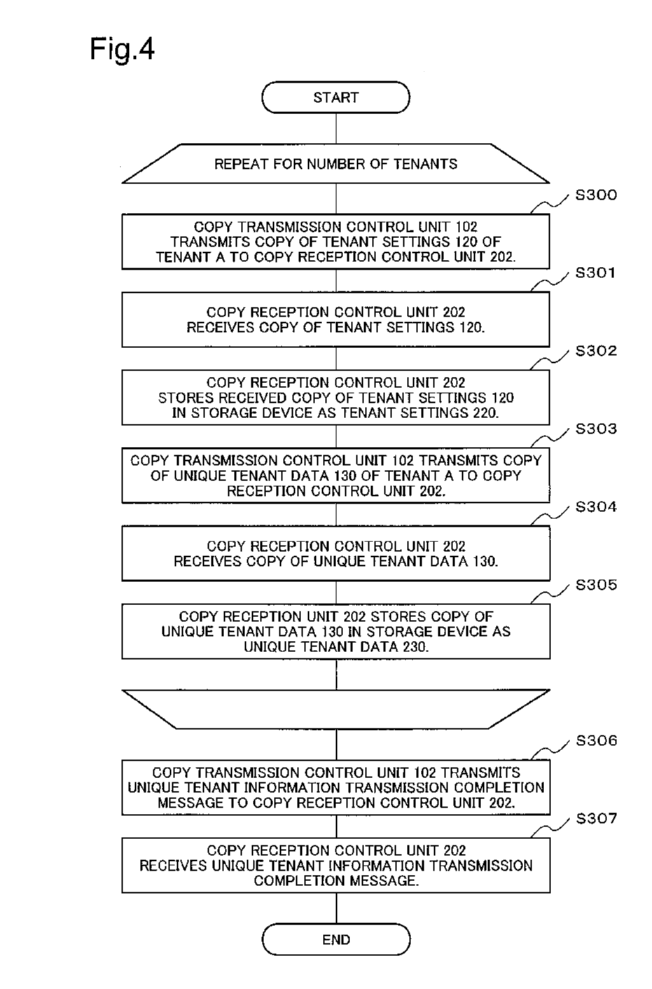

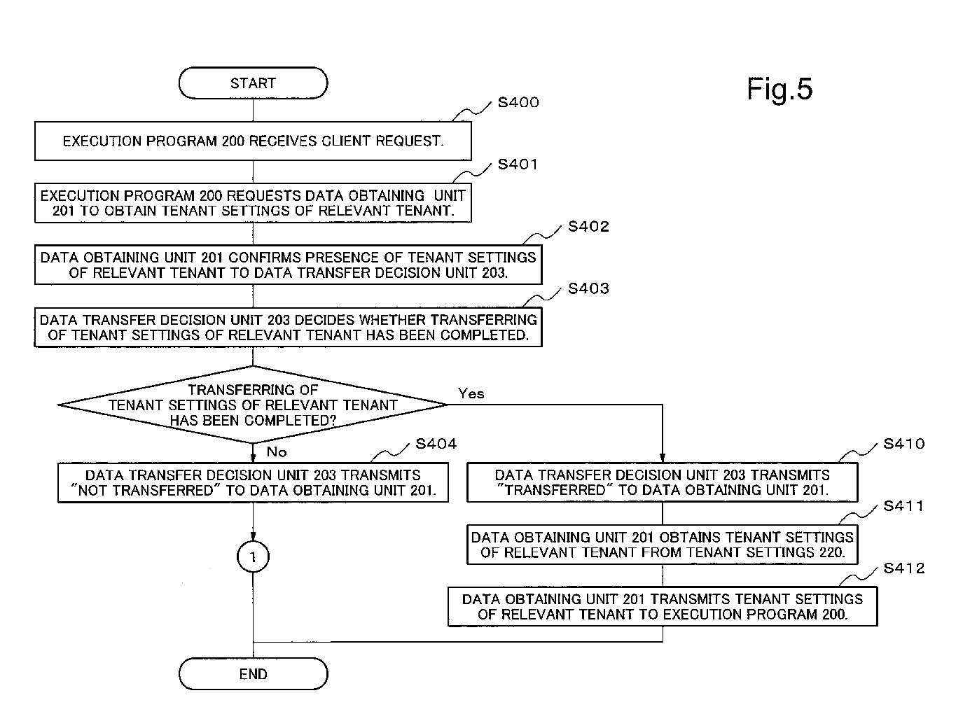

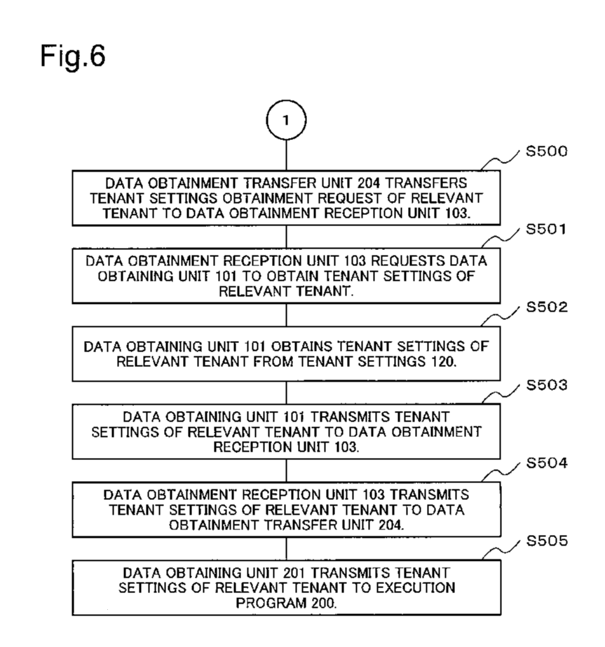

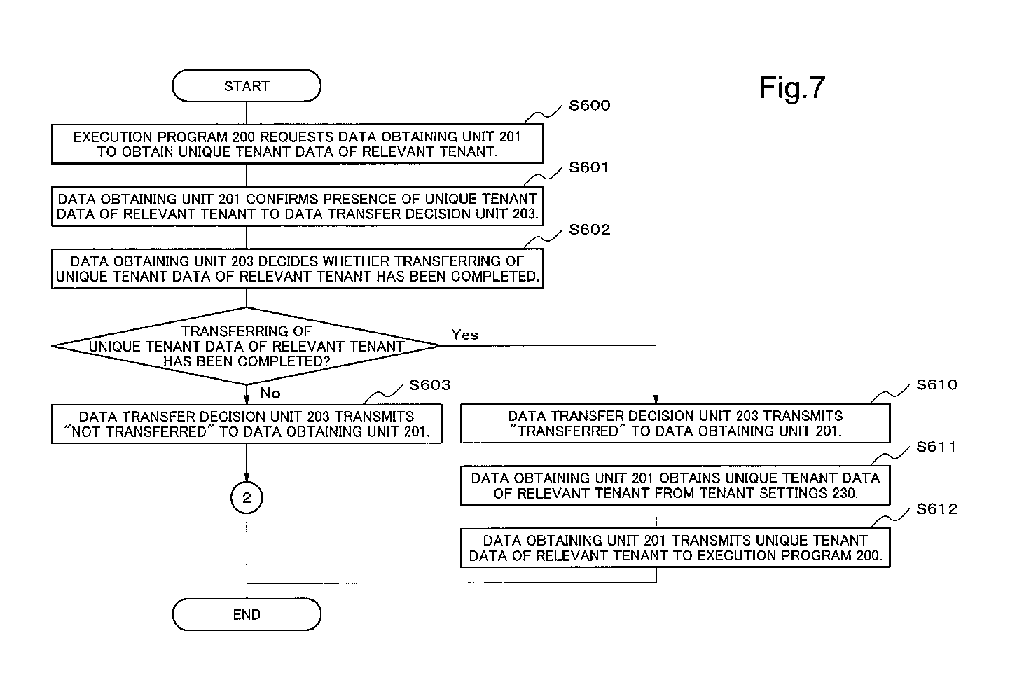

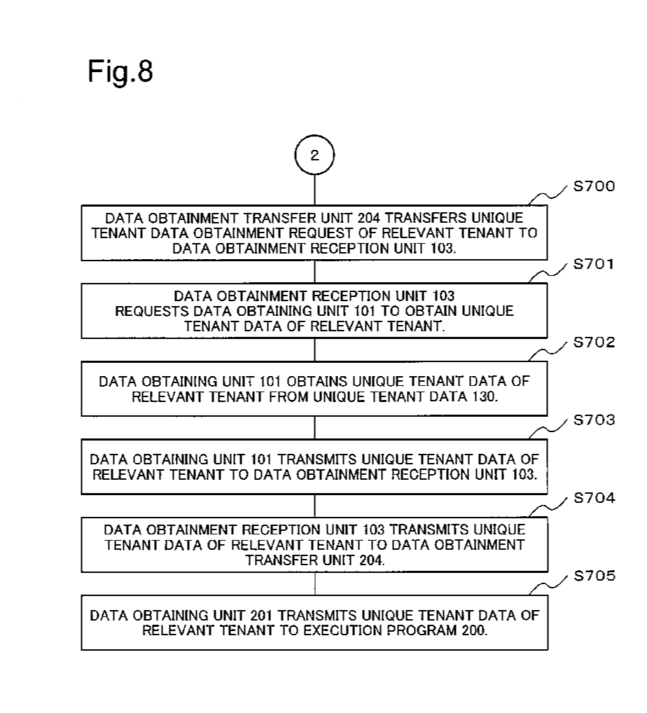

Further, here, equipment on which the copy source application 1 operates and equipment on which the copy destination application execution unit 2 operates may be a virtual machine logically isolated in identical equipment or may be different equipment. Next, operation according to the first exemplary embodiment will be described using FIG. 2, FIG. 3, FIG. 4, FIG. 5, FIG. 6, FIG. 7 and FIG. 8.

First, using FIG. 2, operation to copy and transfer shared part of the application is described.

First, the copy transmission control unit 102 transmits a copy of the execution unit 100 to the copy reception control unit 202 (Step S100). Next, the copy reception control unit 202 receives the copy of the execution unit 100 (Step S101). Next, the copy reception control unit 202 stores the copy of the execution unit 100 received in a storage device which is not illustrated as the execution unit 200 (Step S102).

Also, the copy transmission control unit 102 transmits a copy of the data obtaining unit 101 to the copy reception control unit 202 (Step S103). Next, the copy reception control unit 202 receives the copy of the data obtaining unit 101 (Step S104). Next, the reception unit 202 stores the copy of the data obtaining unit 101 received in a storage device which is not illustrated as the data obtaining unit 201 (Step S105).

Also, the copy transmission control unit 102 transmits a copy of the shared tenant data 110 to the copy reception control unit 202 (Step S106). Next, the copy reception control unit 202 receives the copy of the shared tenant data 110 (Step S107). Next, the copy reception unit 202 stores the copy of the shared tenant data 110 received in a storage device as the shared tenant data 210 shown in FIG. 1 (Step S108).

As above, operation which copies and transfers the shared part of the application ends. Here, three sets of steps: from Step S100 to Step S102, from Step S103 to Step S105 and from Step S106 to Step S108 may be executed simultaneously or its order of execution may be changed.

Next, operation which starts assigning client requests to the copy destination application execution unit 2 will be described using FIG. 3.

First, the copy transmission control unit 102 transmits a shared part transmission completion message to the copy reception control unit 202 (Step S200). The shared part transmission completion message is a message to notify that the flow of FIG. 2 is completed and transmission of the shared part of the application has been completed. The shared part transmission completion message includes pointer information of the data obtainment reception unit 103. The pointer information is information for communicating with the data obtainment reception unit 103 (for example, URL (Uniform Resource Locator)). The copy reception control unit 202 receives the shared part transmission completion message (Step S201). Next, the copy reception control unit 202 notifies the data obtainment transfer unit 204 of the pointer information which indicates a position of the data obtainment reception unit 103 and is included in the shared part transmission completion message (Step S202).

Next, the data obtainment transfer unit 204 receives the pointer information which indicates the position of the data obtainment reception unit 103 and stores the pointer information in a storage device as data obtaining unit pointer information 240 shown in FIG. 1 (Step S203).

Next, the copy reception control unit 202 transmits a request reception possible notification to the request control unit 20 (Step S204). The request reception possible notification is a message for the copy destination application execution unit 2 to request, since it became a state that can receive client requests, assigning the client requests to the copy destination application execution unit 2. The request control unit 20 receives the request reception possible notification (Step S205).

Next, the request control unit 20 adds the copy destination application execution unit 2 (application of copy destination) to a request assignment list (Step S206). Here, the copy destination application execution unit 2 (application of copy destination) added to the request assignment list is the application which, when the request control unit 20 receives the client requests, becomes a candidate to which the request is transferred as a load balancing destination.

As above, operation which starts assigning the client requests to the copy destination application execution unit 2 ends.

Next, operation which copies and transfers the unique tenant information of the application is described using FIG. 4.

First, the copy transmission control unit 102 transmits a copy of the tenant settings 120 to the copy reception control unit 202 (Step S300).

Next, the copy reception control unit 202 receives the copy of the tenant settings 120 (Step S301). Next, the copy reception unit 202 stores the copy of the tenant settings 120 received in a storage device as the tenant settings 220 shown in FIG. 1 (Step S302).

Next, the copy transmission control unit 102 transmits a copy of the unique tenant data 130 to the copy reception control unit 202 (Step S303). Next, the copy reception control unit 202 receives the copy of the unique tenant data 130 (Step S304). Next, the copy reception unit 202 stores the copy of the unique tenant data 130 received in a storage device as the unique tenant data 230 shown in FIG. 1 (Step S305).

The application configuration system 1000 repeats steps from Step S300 to Step S305 for the number of tenants and transfers all of the unique tenant information. Next, the copy transmission control unit 102 transmits a unique tenant information transmission completion message to the copy reception control unit 202 (Step S306). The unique tenant information transmission completion message is a message to notify that for all tenants, the flow from Step S300 to Step S305 is completed and transmission of the unique tenant information of the application has been completed. Further, the copy transmission control unit 102 may transmit, at time when the copy reception control unit 202 received all the specific unique tenant information, a specific unique tenant information transmission completion message to the request control unit 20. Here, which unique tenant information is made the specific unique tenant information may be determined by the user in advance, or by giving the tenants a weight based on a specific evaluation criterion, it may be made the unique tenant information of a predetermined number of the tenants in order of high frequency of utilization. Next, the copy reception control unit 202 receives the unique tenant information transmission completion message (Step S307).

As above, operation which copies and transfers the unique tenant information of the application ends.

Next, operation when the copy destination application execution unit 2 receives client requests and performs different processing for each tenant will be described using FIG. 5 and FIG. 6. This operation is started in parallel with the flow of FIG. 4.

First, the execution unit 200 receives a client request concerning a certain tenant (Step S400). This client request is one assigned by the request control unit 20. Next, the execution unit 200 requests the data obtaining unit 201 to obtain “tenant settings of the relevant tenant” (such as the tenant settings for tenant A 221 and the tenant settings for tenant X 222) (Step S401). Next, the data obtaining unit 201 confirms presence of the tenant settings of the relevant tenant with the data transfer decision unit 203 (Step S402). Next, the data transfer decision unit 203 decides whether transferring of the tenant settings of the relevant tenant has been completed (Step S403). In case the tenant settings of the relevant tenant are not transferred, the data transfer decision unit 203 transmits “not transferred” to the data obtaining unit 201 (Step S404). After that, processing flow of FIG. 6 is executed.

On the other hand, in case the transferring of the tenant settings of the relevant tenant has been completed, the data transfer decision unit 203 transmits “transferred” to the data obtaining unit 201 (Step S410). The data obtaining unit 201 obtains the tenant settings of the relevant tenant from the tenant settings 220 (Step S411). Next, the data obtaining unit 201 transmits the tenant settings of the relevant tenant to the execution unit 200 (Step S412).

Next, operation after Step S404 of FIG. 5 is executed will be described using FIG. 6.

First, the data obtainment transfer unit 204 transfers a tenant settings obtainment request of the relevant tenant to the data obtainment reception unit 103 (Step S500). Next, the data obtainment reception unit 103 requests the data obtaining unit 101 to obtain the tenant settings of the relevant tenant (Step S501). Next, the data obtaining unit 101 obtains the tenant settings of the relevant tenant from the tenant settings 120 (Step S502). Next, the data obtaining unit 101 transmits the tenant settings of the relevant tenant to the data obtainment reception unit 103 (Step S503). Next, the data obtainment reception unit 103 transmits the tenant settings of the relevant tenant to the data obtainment transfer unit 204 (Step S504). Next, the data obtainment transfer unit 204 transmits the tenant settings of the relevant tenant to the data obtaining unit 201 and the data obtaining unit 201 transmits the tenant settings of the relevant tenant to the execution unit 200 (Step S505).

As above, operation when the copy destination application execution unit 2 receives the client requests and performs different processing for each tenant ends.

Next, operation when the execution unit 200 obtains the unique tenant data in its processing will be described using FIG. 7 and FIG. 8.

This operation may be executed simultaneously with the flow of FIG. 4 as far as the flow of FIGS. 5 and 6 is executed.

First, the execution unit 200 requests the data obtaining unit 201 to obtain “a unique tenant data of the relevant tenant” (such as the unique data for tenant A 231 and the unique data for tenant X 232) (Step S600). Next, the data obtaining unit 201 confirms presence of the unique tenant data of the relevant tenant with the data transfer decision unit 203 (Step S601). Next, the data transfer decision unit 203 decides whether transferring of the unique tenant data of the relevant tenant has been completed (Step S602). In case the unique tenant data of the relevant tenant is not transferred, the data transfer decision unit 203 transmits “not transferred” to the data obtaining unit 201 (Step S603). After that, processing flow of FIG. 8 is executed.

On the other hand, in case the transferring of the unique tenant data of the relevant tenant has been completed, the data transfer decision unit 203 transmits “transferred” to the data obtaining unit 201 (Step S610).

Next, the data obtaining unit 201 obtains the unique tenant data of the relevant tenant from the unique tenant data 230 (Step S611). Next, the data obtaining unit 201 transmits the unique tenant data of the relevant tenant to the execution unit 200 (Step S612).

Next, operation after Step S603 is executed will be described using FIG. 8.

First, the data obtainment transfer unit 204 transfers a unique tenant data obtainment request of the relevant tenant to the data obtainment reception unit 103 (Step S700). At that time, the data obtainment transfer unit 204 obtains a communication destination to the data obtainment reception unit 103 from the data obtaining unit pointer information 240. Next, the data obtainment reception unit 103 requests the data obtaining unit 101 to obtain the unique tenant data of the relevant tenant (Step S701). Next, the data obtaining unit 101 obtains the unique tenant data of the relevant tenant from the unique tenant data 130 (Step S702). Next, the data obtaining unit 101 transmits the unique tenant data of the relevant tenant to the data obtainment reception unit 103 (Step S703). Next, the data obtainment reception unit 103 transmits the unique tenant data of the relevant tenant to the data obtainment transfer unit 204 (Step S704). Next, the data obtaining unit 201 transmits the unique tenant data of the relevant tenant to the execution unit 200 (Step S705).

As above, operation in case the execution unit 200 obtains the unique tenant data in its processing ends.

Next, effects according to this exemplary embodiment of the present invention will be described.

In the exemplary embodiment, the application configuration system 1000 starts request reception while not waiting for transmission completion of all of the unique tenant information copied for load balancing. Therefore, for the application configuration system 1000, load balancing with high immediacy becomes possible even in case a great deal of tenants are hosted and amount of the tenant settings and the unique tenant data which are the unique tenant information becomes enormous.

### Second Exemplary Embodiment

Next, the second exemplary embodiment of the present invention will be described. In the second exemplary embodiment of the present invention, an application configuration system 1000 which, in copying of the unique tenant information, gives a weight based on its frequency of utilization and changes copying order will be described.

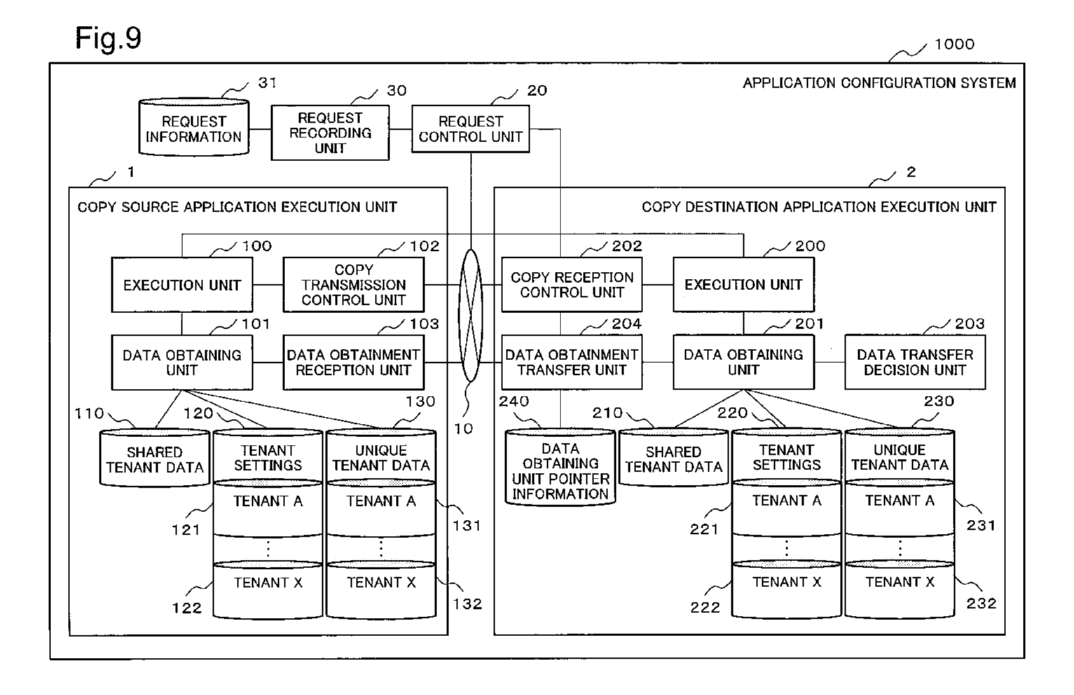

A configuration according to this exemplary embodiment will be described with reference to FIG. 9. The application configuration system 1000 according to this exemplary embodiment includes a request storage unit 30 in addition to the configuration of the first exemplary embodiment.

The request recording unit 30 includes a function to record to which tenant client requests correspond.

Operation according to this exemplary embodiment will be described.

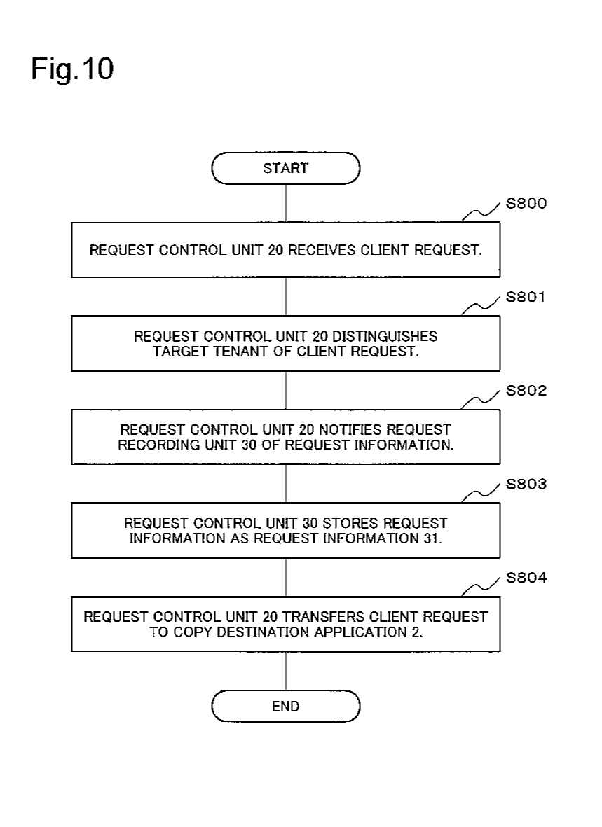

First, operation when the request control unit 20 receives a client request will be described using FIG. 10.

First, the request control unit 20 receives a client request (Step S800). Next, the request control unit 20 distinguishes a target tenant of the client request (Step S801). Next, the request control unit 20 notifies the request recording unit 30 of request information (Step S802). Here, the request information is information included in the client request and is, for example, the target tenant, time, URL of the request, an IP address of equipment of the request source, authentication information of the request and so on. Next, the request recording unit 30 stores the request information in a recording device, for example, as request information 31 shown in FIG. 9 (Step S803). Next, the request control unit 20 transfers the client request to the copy destination application execution unit 2 (Step S804). Further, Step S803 and Step S804 may be executed simultaneously.

As above, operation when the request control unit 20 receives the client requests ends.

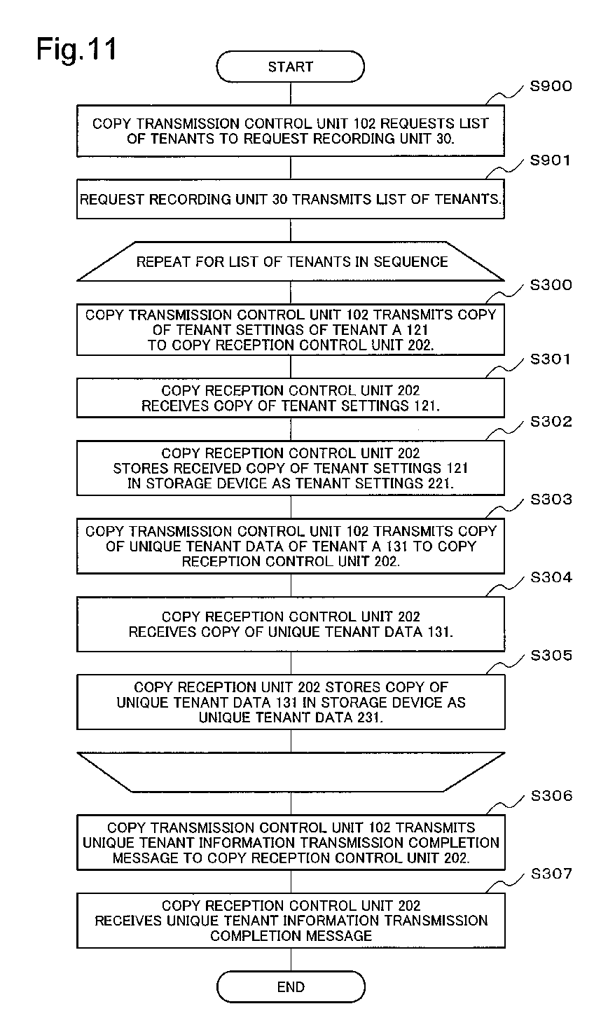

Next, operation of this exemplary embodiment corresponding to the operation when the copy destination application execution unit 2 receives the client requests and performs different processing for each tenant which is described in the first exemplary embodiment using FIG. 4, will be described using FIG. 11.

First, the copy transmission control unit 102 requests the request recording unit 30 a list of tenants (Step S900). The request recording unit 30 transmits the list of tenants (Step S901). At that time, the list of tenants transmitted is a list with an order which the request recording unit 30 generates using the request information 31. In the request information 31, client requests accumulated in the past may be included. As a generation method of the list of tenants, a method which gives a weight to the tenants based on a specific evaluation criterion and sorts them in order of high frequency of utilization is known. The request recording unit 30 may sort the tenants, for example, using a number of receptions of the requests for the tenants in the past. Or the request recording unit 30 may sort the tenants by using such as information of time in addition and using a method to evaluate the frequency of utilization of the tenants more correctly. The request recording unit 30 may use other existing methods as the method to give the weight.

A point of difference between the operation afterwards and the operation according to the first exemplary embodiment will be described. In the first exemplary embodiment, the operation from Step S300 to Step S305 of FIG. 4 is repeated without ordering and for the number of tenants. On the other hand, in the exemplary embodiment, from Step S300 to Step S305 are repeatedly executed in the order of the list of ordered tenants which is got in Step S901 of FIG. 11.

The copy transmission control unit 102 may transmit the specific unique tenant information transmission completion message to the request control unit 20 at time when the copy reception control unit 202 received all the specific unique tenant information. Here, which unique tenant information is made the specific unique tenant information may be determined by the use in advance, or as described above, may be determined by giving the tenants the weight based on the specific evaluation criterion and selecting the predetermined number of the tenants in order of high frequency of utilization. Also, when the specific unique tenant information transmission completion message is received, the request control unit 20 may transfer only the client requests for the tenants for which copying of the unique tenant information has been completed to the copy destination application execution unit 2.

The application configuration system 1000 according to this exemplary embodiment can, by copying with priority the unique tenant information of the tenants which are frequently used, balance load of the tenants quickly to which the load tends to concentrate.

Also, the application configuration system 1000 according to this exemplary embodiment can process the client requests at time when the specific unique tenant information is transferred to the copy destination application execution unit. Therefore, the application configuration system 1000 can solve the problem that the client requests cannot be processed until deployment of all of the objects to be deployed has been completed.

### Third Exemplary Embodiment

Next, the third exemplary embodiment of the present invention will be described. An application configuration system 1000 according to the third exemplary embodiment of the present invention, in case a unique tenant data is not copied in the copy destination application execution unit 2, obtains the unique tenant data 130 from the copy source application execution unit 1, and at the same time, manages a part of the unique tenant data 130 obtained as ones of which copying has been completed and copies the unique tenant data step by step.

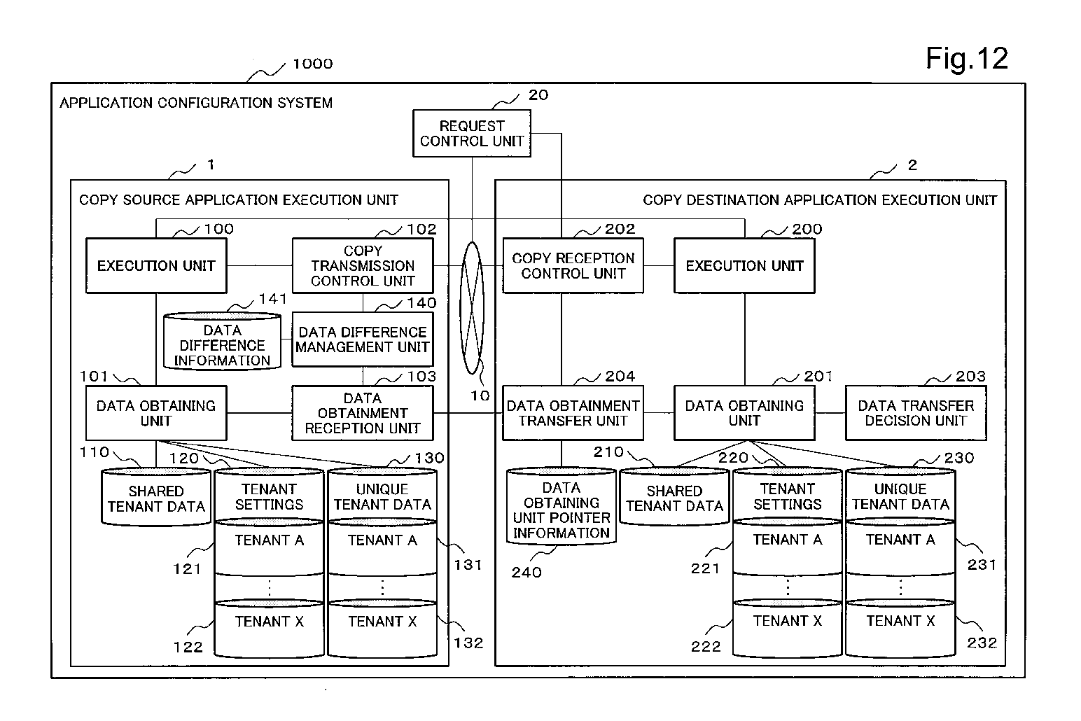

First, a configuration of this exemplary embodiment will be described. FIG. 12 is a block diagram showing the configuration of this exemplary embodiment. In FIG. 12, the application configuration system 1000 includes a data difference management unit 140 in addition to the configuration of the first exemplary embodiment.

The data difference management unit 140 includes a function to record a copy history of some data of the tenant settings 120 (partial data of the tenant settings 120) which was copied by the operation when the execution unit 200 obtains the tenant settings 120 in its processing (refer to FIG. 6). Also, the data difference management unit 140 includes a function to extract the tenant settings 120 except for the partial data of the tenant settings 120 of which copying has been completed when whole of the tenant settings 120 is copied by the operation which copies and transfers the unique tenant information of the application (from Step S300 to Step S305 of FIG. 4). Also, the data difference management unit 140 includes a function to record a copy history of some data of the unique tenant data 130 (partial data of the unique tenant data 130) which was copied by the operation when the execution unit 200 obtains the unique tenant data 130 in its processing (refer to FIG. 8). Also, the data difference management unit 140 includes a function to extract the unique tenant data 130 except for the partial data of the unique tenant data 130 of which copying has been completed when whole of the unique tenant data 130 is copied by the operation which copies and transfers the unique tenant information of the application (from Step S300 to Step S305 of FIG. 4).

Next, operation according to this exemplary embodiment will be described.

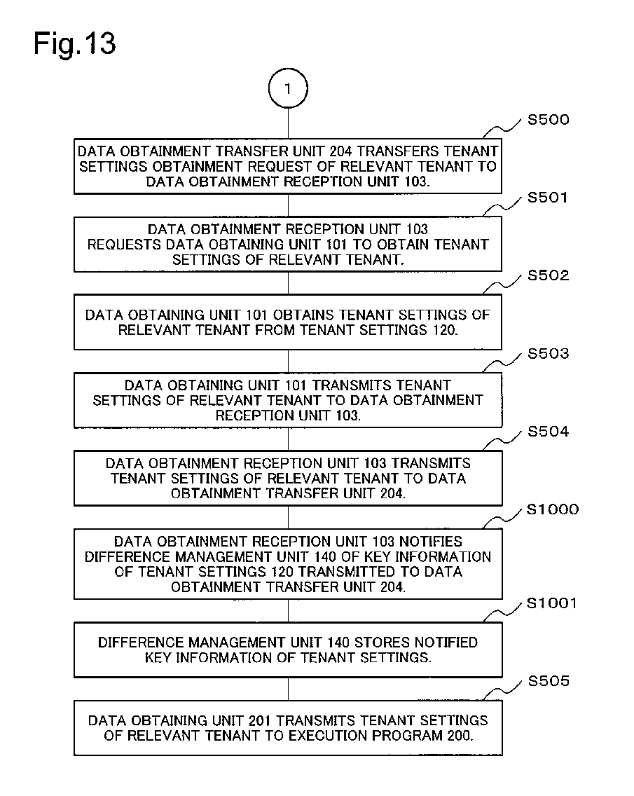

Operation when the copy destination application execution unit 2 receives client requests and performs different processing for each tenant will be described using FIG. 13.

First, description concerning the operation from Step S500 to Step S504 in FIG. 13 will be omitted. This is because it is identical with the operation from Step S500 to Step S504 of FIG. 6 according to the first exemplary embodiment mentioned above. Next, the data obtainment reception unit 103 notifies the difference management unit 140 of key information of the partial data of the tenant settings 120 (key information of the tenant settings 120) transmitted to the data obtainment transfer unit 204 (Step S1000). Here, the key information of the partial data of the tenant settings 120 (key information of the tenant settings 120) is information which can extract the relevant partial data from whole of the tenant settings uniquely. In many cases, since the tenant settings 120 are stored in a database, the key information of the tenant settings 120 is its record key and so on.

Next, the difference management unit 140 stores the key information of the tenant settings which was notified, for example, as data difference information 141, in a recording device (Step S1001). After that, the data obtaining unit 201 transmits the tenant settings of the relevant tenant to the execution unit 200 like Step S505 of FIG. 6 (Step S505).

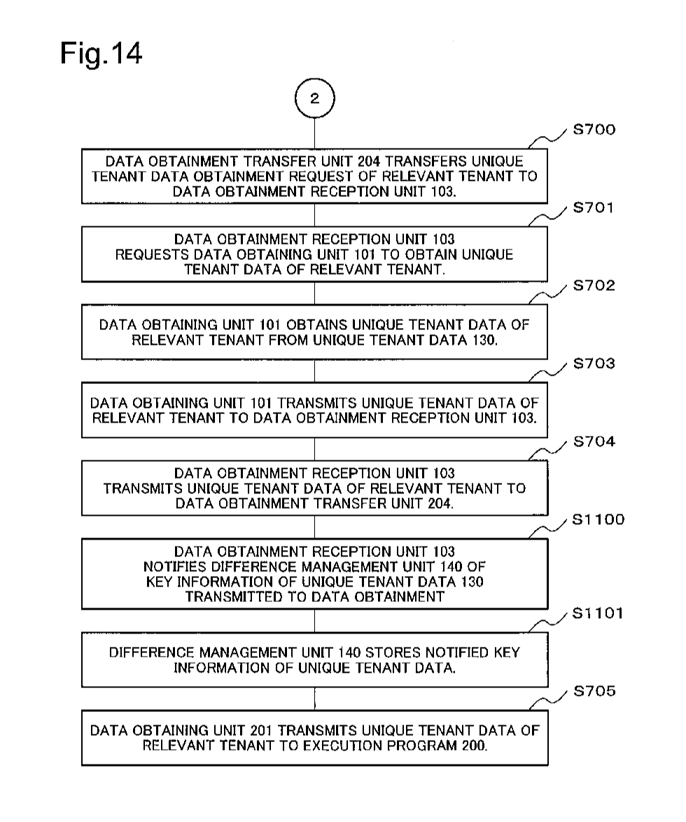

Next, operation in case the execution unit 200 obtains the unique tenant data 130 in its processing will be described using FIG. 14.

First, description concerning the operation from Step S700 to Step S704 will be omitted. This is because it is identical with the operation from Step S700 to Step S704 of FIG. 8 according to the first exemplary embodiment. Next, the data obtainment reception unit 103 notifies the difference management unit 140 of key information of the partial data of the unique tenant data 130 (key information of the unique tenant data 130) transmitted to the data obtaining unit 204 (Step S1100). Here, the key information of the partial data of the unique tenant data 130 (key information of the unique tenant data 130) is information which can extract the relevant partial data from whole of the unique tenant data uniquely. The key information of the unique tenant data 130 is, for example, when the unique tenant data 130 is data stored in a database, its record key. Also, the key information of the unique tenant data 130 is, when the unique tenant data 130 is resources such as an image file, its file name and so on.

Next, the difference management unit 140 stores the key information of the unique tenant data which was notified, for example, as the data difference information 141, in a recording device (Step S1101). After that, the data obtaining unit 201 transmits the unique tenant data of the relevant tenant to the execution unit 200 like Step S705 of FIG. 8 (Step S705).

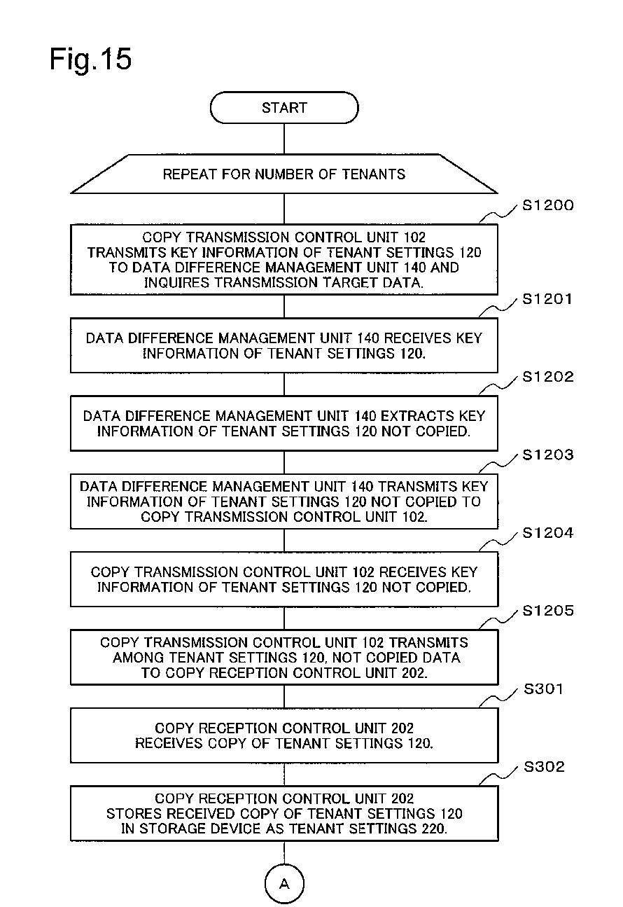

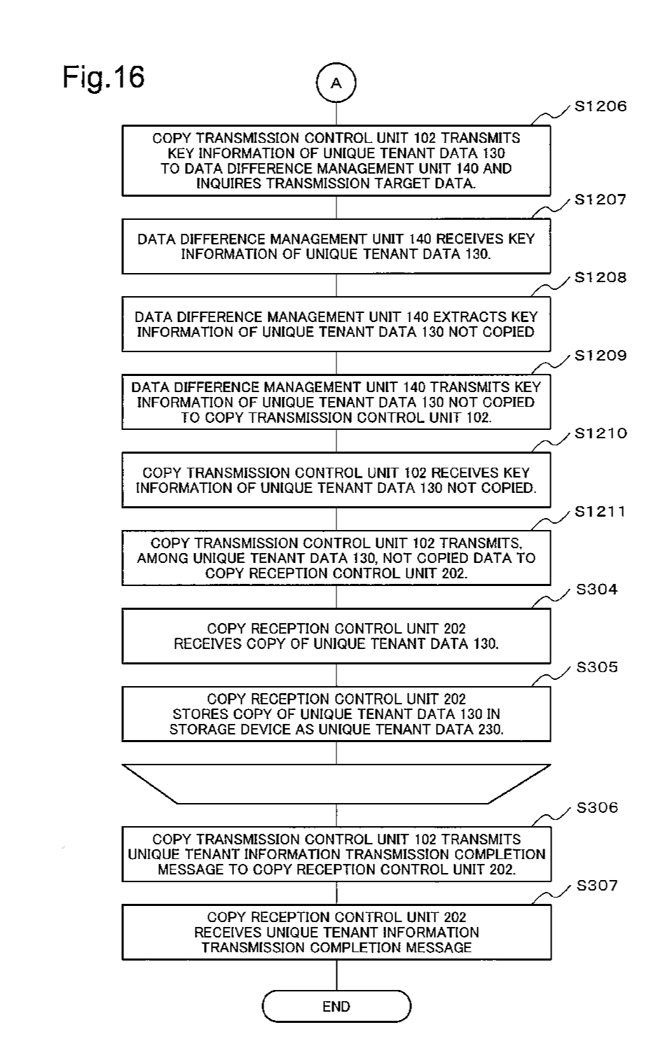

Next, operation which copies and transfers unique tenant information of the application will be described using FIG. 15 and FIG. 16.

First, the copy transmission control unit 102 inquires a transmission target data by transmitting the key information of the tenant settings 120 to the data difference management unit 140 (Step S1200). Here, the copy transmission control unit 102 may obtain the key information of the tenant settings 120 from a storage unit which is not illustrated and which holds a list of required unique information for each tenant or the unique tenant information of all of the tenants including the key information of the tenant settings 120, and transmit it to the data difference management unit 140. Next, the data difference management unit 140 receives the key information of the tenant settings 120 (Step S1201). Next, the data difference management unit 140 extracts the key information of the tenant settings of copying target except for the partial data of the tenant settings 120 of which copying has been completed and which is recorded in the data difference information 141 (Step S1202). Next, the data difference management unit 140 transmits the key information of the tenant settings 120 of copying target to the copy transmission control unit 102 (Step S1203). Next, the copy transmission control unit 102 receives the key information of the tenant settings 120 of copying target (Step S1204). Next, the copy transmission control unit 102 transmits only the data of copying target among the tenant settings 120 (data not copied) to the copy reception control unit 202 (Step S1205). Next, the copy reception control unit 202 receives the copy of the tenant settings 120 (Step S301) and stores the copy of the tenant settings 120 received in a storage device as the tenant settings 220 (Step S302).

Next, the copy transmission control unit 102 inquires a transmission target data by transmitting the key information of the unique tenant data 130 to the data difference management unit 140 (Step S1206). Next, the data difference management unit 140 receives the key information of the unique tenant data 130 (Step S1207). Next, the data difference management unit 140 extracts the key information of the unique tenant data 130 of copying target except for the partial data of the unique tenant data 130 of which copying has been completed and which is recorded in the data difference information 141 (Step S1208). Next, the data difference management unit 140 transmits the key information of the unique tenant data 130 of copying target to the copy transmission control unit 102 (Step S1209). Next, the copy transmission control unit 102 receives the key information of the unique tenant data 130 of copying target (Step S1210). Next, the copy transmission control unit 102 transmits only the data of copying target among the unique tenant data 130 (data not copied) to the copy reception control unit 202 (Step S1211). Next, the copy reception control unit 202 receives only the data of copying target among the unique tenant data 130 (Step S304), and the copy reception unit 202 stores the data concerned in a storage device as the unique tenant data 230 (Step S305). Below is the same as the operation of the first exemplary embodiment (refer to FIG. 4). The copy transmission control unit 102 transmits the unique tenant information transmission completion message to the copy reception control unit 202 (Step S306), and the copy reception control unit 202 receives the unique tenant information transmission completion message (Step S307).

The application configuration system 1000 according to this exemplary embodiment can, in case the tenant settings 120 or the unique tenant data 130 which are different for each tenant are not copied in the copy destination application execution unit 2, by requesting the copy source application execution unit 1 to obtain those data and at the same time, by recording the partial data obtained as the data of which copying has been completed and utilizing them, reduce the number of communications between the application execution units.

### Fourth Exemplary Embodiment

Next, the fourth exemplary embodiment of the present invention will be described. An application configuration system 1000 according to the fourth exemplary embodiment of the present invention includes: the copy destination application execution unit 2 including the execution unit 200 and the data obtaining unit 201. Since their configuration and operation are as mentioned above, their description will be omitted.

According to this exemplary embodiment, the application configuration system is provided a second application execution means which includes, the execution means which, after the copy reception control means which makes the storage means store the shared tenant data and the unique tenant information which are copied from the first application execution means to the second application execution means obtains a copy of the shared tenant data from the first application execution means, executes processing according to the request information which is inputted from a terminal and is transferred from the request control means to the second application execution means; and the data obtaining means which, when the execution means refers the unique tenant information, obtains the copied unique tenant information in case copying of the unique tenant information to the second application execution means is completed, and obtains the unique tenant information of the first application execution means and outputs it to the execution means in case the copyingis not completed, obtains copied the unique tenant information, and in case the copying is not completed, obtains the unique tenant information of the first application execution means and outputs to the execution means.

The application configuration system 1000 of this exemplary embodiment does not wait for transmission completion of all of the unique tenant information copied for load balancing and starts request reception. Accordingly, the application configuration system, the method and the program which enables processing of client requests before deployment of all of the objects to be deployed has been completed are provided.

Although the present invention has been described with reference to the exemplary embodiments above, the present invention is not limited to the exemplary embodiments mentioned above. Various changes which a person skilled in the art can understand within the scope of the present invention can be performed in the composition of the present invention and details.

This application claims priority based on Japanese application Japanese Patent Application No. 2010-198956 filed on Sep. 6, 2010, the disclosure of which is incorporated herein in its entirety.

### DESCRIPTION OF THE CODE

20 Request control unit
30 Request recording unit
100 Execution unit
101 Data obtaining unit
102 Copy transmission control unit
103 Data obtainment reception unit
110 Shared tenant data
120 Tenant settings
130 Unique tenant data
140 Data difference management unit
141 Data difference information
200 Execution unit
201 Data obtaining unit
202 Copy reception control unit
203 Data transfer decision unit
204 Data obtainment transfer unit
210 Shared tenant data
220 Tenant settings
230 Unique tenant data
1000 Application configuration system

1.-10. (canceled)

11. An application configuration system comprising:
a second application execution unit which includes,
an execution unit which, after a copy reception control unit which makes a storage unit store a shared tenant data and unique tenant information copied from a first application execution unit to said second application execution unit obtains a copy of said shared tenant data from said first application execution unit, executes processing according to request information which is inputted from a terminal and is transferred from a request control unit to said second application execution unit; and
a data obtaining unit which, when said execution unit refers said unique tenant information, in case copying of said unique tenant information to said second application execution unit is completed, obtains copied said unique tenant information, and in case said copying is not completed, obtains said unique tenant information of said first application execution unit and outputs to said execution unit.

12. The application configuration system according to claim 11 wherein said second application execution unit further include,
a request storage unit which determines order in which said copying is performed among said unique tenant information based on tenant's information included in said request information; and
said copy reception control unit which stores a copy of said unique tenant information in said order which said request storage unit determines.

13. The application configuration system according to claim 11 further comprising:
said first application execution unit which includes:
a data obtainment reception unit which transmits said unique tenant information requested from said second application execution unit to said second application execution unit; and
a data difference management unit which stores a history of said unique tenant information which said data obtainment reception unit transmitted to said second application execution unit, and extracts, among said unique tenant information, said unique tenant information is not stored in said history; wherein
said copy reception control unit receives from said data difference management unit a copy of said unique tenant information extracted.

14. The application configuration system according to claim 11, wherein said copy reception control unit notifies said request control unit, at time when it receives all said unique tenant information of specific tenants, of unique tenant information copy completion of said specific tenants; and
said request control unit transfers only said request information for tenants of which unique tenant information copying is completed to said second application execution unit.

15. An application configuration system comprising:
a second application execution means for including,
an execution means for, after a copy reception control means which makes a storage means store a shared tenant data and unique tenant information copied from a first application execution means to a second application execution means obtains a copy of said shared tenant data from said first application execution means, executing processing according to request information which is inputted from a terminal and is transferred from a request control means to said second application execution means; and
a data obtaining means for when said execution means refers said unique tenant information, in case copying of said unique tenant information to said second application execution means is completed, obtaining copied said unique tenant information, and in case said copying is not completed, obtaining said unique tenant information of said first application execution means and outputting to said execution means.

16. An application configuration method comprising:
among an execution program, a shared tenant data and unique tenant information copied from a first application execution unit to said second application execution unit, after obtaining a copy of said execution program and a copy of said shared tenant data from said first application execution unit, transferring request information inputted from a terminal to said second application execution unit;
executing said execution program according to said request information;
when referring said unique tenant information, obtaining copied said unique tenant information in case copying of said unique tenant information to said second application execution unit is completed; and obtaining said unique tenant information of said first application execution unit in case said copying is not completed and
outputting to said execution program.

17. The application configuration method according to claim 16 further comprising:
based on tenant's information included in said request information, determining order in which said copying is performed among said unique tenant information; and
storing a copy of said unique tenant information in said determined order.

18. The application configuration method according to claim 16 further comprising:
transmitting said unique tenant information to said second application execution unit;
storing a history of said transmitted unique tenant information concerned;
extracting, among said unique tenant information, said unique tenant information is not stored in said history; and receiving a copy of said unique tenant information extracted.

19. The application configuration method according to claim 16 further comprising:
at time when said unique tenant information of specific tenants is all received, notifying of unique tenant information copy completion of said specific tenants; and
transferring only said request information for the tenants of which unique tenant information copying is completed to said second application execution unit.

20. A non-transient machine-readable medium which records an application configuration program making a second computer to execute,
a copy reception control step which makes a storage unit store an execution program, a shared tenant data and unique tenant information copied from a first computer to said second computer;
an execution step which, in said copy reception control step, after a copy of said execution program and a copy of said shared tenant data are obtained from said first computer in said copy reception control step, executes said execution program according to request information which is inputted from a terminal and is transferred to said second computer; and
a data obtaining step which, in said execution step, when referring said unique tenant information, obtains copied said unique tenant information in case copying of said unique tenant information to said second computer is completed, and obtains said unique tenant information of said first computer in case said copying is not completed and makes said execution step refer.

21. The non-transient machine-readable medium according to claim 20 which records the application configuration program making said second computer execute said copy reception control step which determines order in which said copying is performed among said unique tenant information based on tenant's information included in said request information and stores a copy of said unique tenant information in said order thus determined.
